(19) United States
(12) Patent Application Publication
(10) Pub. No.: US 2015/0013804 A1
(43) Pub. Date: Jan. 15, 2015

(54) FLOW RESPONSIVE LATCH FOR HOLDING A SPOOL VALVE IN AN OPEN POSITION

(71) Applicant: HUSCO International, Inc., Waukesha, WI (US)

(72) Inventor: Gary J. Pieper, Eagle, WI (US)

(21) Appl. No.: 13/938,607

(22) Filed: Jul. 10, 2013

(51) Int. Cl. F16K 11/07

(52) U.S. Cl. CPC F16K 11/0704
USPC 137/624.27

(57) ABSTRACT

A valve includes a body with a spool bore, a supply passage, a tank passage, and a workport. A spool, in the spool bore, has a first position providing a first path between the supply passage and the workport, a second position providing a second path between the tank passage and the workport, and a closed position. A latch assembly includes a cam that moves in response to pressure, a sphere engaged by the cam, and a notch. While the spool is in the second position, fluid flowing from the workport to the tank passage produces a first pressure, which causes the cam to hold the sphere in the notch, thereby inhibiting spool movement; and when the fluid flow from the workport to the tank passage terminates, a second pressure is produced causing the cam allow the sphere to move out of the notch, thereby enabling the spool movement.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to spool-type hydraulic valves, and more particularly to mechanisms for controlling the motion of the spool in such valves.

2. Description of the Related Art

Many types of equipment have hydraulic systems for moving different components. For example, a backhoe is a common type of construction equipment used for digging into the earth. The backhoe has a tractor body from which extends a boom assembly that has a bucket at the remote end. A user of the backhoe moves levers that operate valves which control the flow of fluid to and from hydraulic cylinders on the boom assembly that enable the bucket to dig into the earth and carry a quantity of earth to another location.

During a digging operation, a pair of stabilizers, comprising legs and foot pads, extend outward from the opposite sides of the tractor to engage the earth. The stabilizers aid in supporting tractor against the forces exerted thereon by the digging operation. After the digging operation, the stabilizers are retracted so that the tractor can be moved to another location. In order to retract the stabilizers, the backhoe user manipulates a pair of levers to hold open valves that operate the hydraulic cylinders connected to the stabilizers. The user must hold the levers to maintain the valves open until the stabilizers reach the fully raised positions.

It is desirable to enable the user to manipulate the levers to open the control valves and then be able to release the levers and have the associated valves remain open until the stabilizers reach the fully raised position, at which time the hydraulic valves would close automatically. This would enable the operator to change operating positions from the one for performing the digging function to another position for driving the tractor to a new location sooner than if the operator had to hold onto the levers until the stabilizers were fully raised.

Other types of equipment would also benefit from a similar feature in which once a control valve is manually opened, the control lever could be released allowing the related machine operation to continue until completion, at which time the control valve automatically closes. For example, retracting the wedge of log splitter in this manner after a log has been split would allow the operator to grab another log while the wedge is retracting, thereby increasing operator productivity. The present latch feature also can be used on telescopic forklifts and cranes.

### SUMMARY OF THE INVENTION

A hydraulic valve comprises a body having a spool bore therein and a supply passage for receiving pressurized fluid, a tank return passage for connection to a tank, and a workport for connection to a hydraulic actuator.

A spool is slideably received in the spool bore. The spool has a first position in which a first fluid path is provided between the supply passage and the workport, a second position in which a second fluid path is provided between the tank return passage and the workport, and a neutral position in which the workport is closed off from both the supply passage and the tank return passage. The spool has a control passage that, in the second position, is in fluid communication with the workport.

A latch includes a cam that moves in response to pressure in the control passage, a sphere engaged by a surface of the cam, and a notch for receiving the sphere to inhibit motion of the spool when the cam moves into the first position. While the spool is in the second position, fluid flowing from the workport to the tank return passage produces a first pressure level in control passage, which causes the cam to hold the sphere in the notch, thereby inhibiting the spool from moving from the second position. When the fluid flow from the workport to the tank return passage terminates, a second pressure level is produced in the control passage which causes the cam to retract, allowing the sphere to move out of the notch, thereby enabling the spool to move from the second position.

In one aspect of the invention, the cam is coupled to a latch piston by a detent spring and the pressure in the control passage is applied to the latch piston.

In another aspect of the invention, the spool has a cam bore and the cam is moveably received within the cam bore. The spool has an aperture extending between the cam bore and the spool bore with the sphere received within the aperture. The notch is located within the spool bore.

### BRIEF DESCRIPTION OF THE DRAWINGS

FIG. 1 is a cross section through a valve in a neutral position, wherein the present spool latch is incorporated into that valve;

FIG. 2 is an enlarged cross section view of the spool latch in FIG. 1; and

FIG. 3 is a cross section view through the valve with a spool held in an open position by the spool latch.

### DETAILED DESCRIPTION OF THE INVENTION

Although the present invention is being described in the context of use on a backhoe, the inventive concepts can be applied to other types of hydraulically operated machines. The valve incorporating the inventive latch is used in a backhoe that has a double acting cylinder-piston arrangement, however, the latch can be used to control other kinds of hydraulic actuators, such as a single acting cylinder-piston arrangement or a hydraulic motor.

Reference herein to directional relationships and movement, such as top and bottom or left and right, refer to the relationship and movement of the components in the orientation illustrated in the drawings, which may not be the orientation and motion of the components as attached to machinery. The term “directly connected” as used herein means that the associated components are connected together by a conduit without any intervening element, such as a valve, an orifice or other device, which restricts or controls the flow of fluid beyond the inherent restriction of any conduit.

### Valve Construction

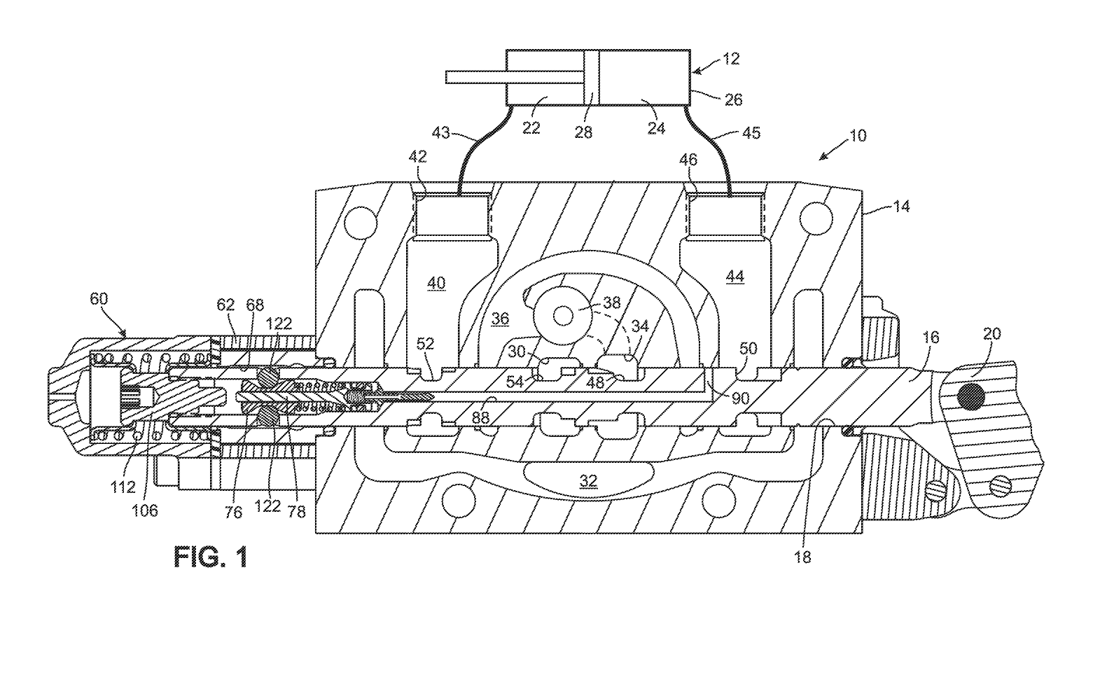

With initial reference to FIG. 1, a portion of a hydraulic system for operating a stabilizer on a backhoe comprises a valve 10 for controlling a hydraulic actuator 12, such as a double acting cylinder-piston arrangement, connected between the stabilizer and the backhoe tractor. The valve 10 may be one section of a larger assembly in which several similar valve sections are mounted side-by-side with each section controlling flow of fluid to and from a different hydraulic actuator on the backhoe. Each valve section has a supply passage that communicates with the supply passages in the adjacent sections to receive pressurized fluid from a pump on the backhoe. Each valve section also has a tank return passage that communicates with the similar passages in the adjacent sections to send fluid back to the reservoir or tank of the hydraulic system on the backhoe. Such assembly of several abutting valve sections is well-known in hydraulic systems. It should be appreciated that the present inventive concept can be used with multiple spool valves located in a single manifold block.

Specifically, the valve 10 has a valve housing 14 with a spool bore 18 within which a spool 16 is slideably received. The backhoe operator can move the spool 16 in either reciprocal direction within the spool bore 18 by manipulating an actuator lever 20 attached to one end of the spool. Depending on which direction the spool 16 is moved, pressurized fluid is directed to a first chamber 22 or a second chamber 24 of a hydraulic cylinder 26 which thereby drives a piston 28 right or left, respectively, in the cylinder. While the fluid is flowing into one cylinder chamber, fluid is forced out of the other chamber through the valve 10.

The valve housing 14 has a supply passage 30 that receives pressurized fluid from a pump and which opens into the spool bore 18. A tank return passage 32 also opens into the spool bore 18. A feed chamber 34 extends around the spool bore 18 at a location adjacent to the supply passage 30. A bridge passage 36 opens into the spool bore 18 at two locations on opposites sides of the supply passage 30 and the feed chamber 34. The bridge passage 36 is coupled to the feed chamber 34 by a conventional load holding check valve 38 that allows fluid to flow only in a direction from the feed chamber into the bridge passage. A first workport passage 40 extends from the spool bore 18 to a first workport 42 to which the first chamber 22 of the hydraulic actuator 12 is connected by a conduit 43. A second workport passage 44 extends from the spool bore 18 to a second workport 46 to which the second chamber 24 of the hydraulic actuator 12 is connected by a conduit 45. The valve 10 is illustrated in FIG. 1, in the neutral (or closed) position, where the spool is centered in the spool bore and in which fluid cannot flow into or out of the workports 42 and 46 and thus the two chambers 22 and 24 of the hydraulic actuator 12.

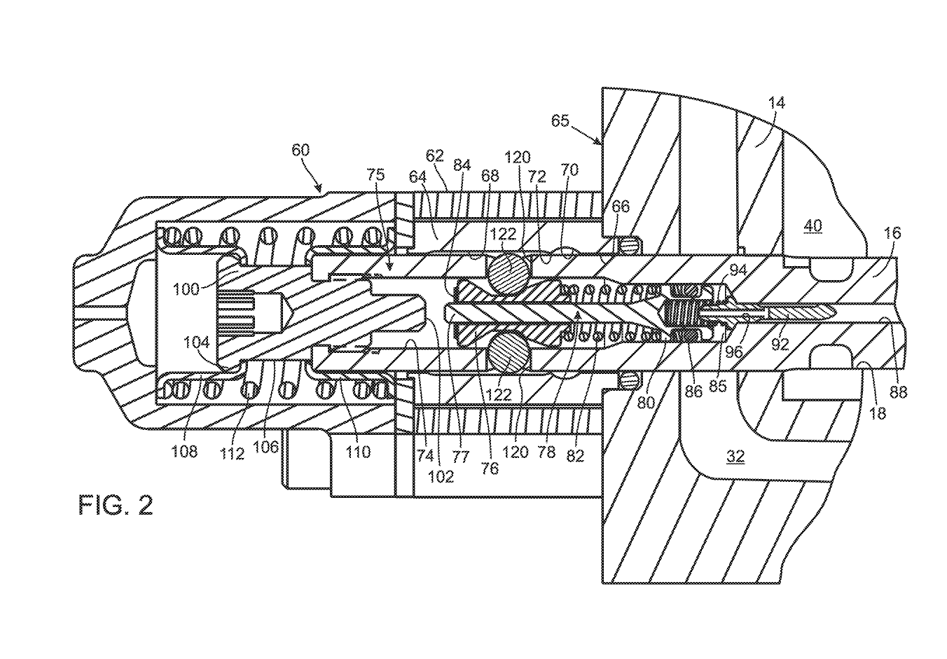

The valve 10 includes a latch 60 attached to the opposite end of the spool 16 from the actuator lever 20. With reference to FIG. 2, the latch 60 has a latch housing 62 secured to the valve housing 14. The valve housing 14 and the latch housing 62 form a valve body 65 and alternatively those separate housings can be combined into a single piece of material. The valve housing 14 has a detent bore 66 that is an extension of the spool bore 18. The detent bore 66 portion of the spool bore 18 has a detent sleeve 64 affixed therein and having an elongated annular groove 68 and an annular detent notch 70 separated by an annular rib 72. Alternatively instead of having a separate detent sleeve 64, the detent bore 66 can be formed directly in the latch housing 62 and the groove 68 and the detent notch 70 can be formed in the wall of that detent bore.

The end portion of the spool 16 that extends into valve housing 14 forms a latch casing 75 and has a cam bore 74 therein. An hour glass shaped cam 76 is slideably received within the cam bore 74 in order to slide on the stem 77 of the latch piston 78. The cam 76 has an aperture between the ends and through which a portion of a latch piston 78 extends. An interior end of the latch piston 78 has as circular flange 80 that is engaged by one end of a detent spring 82, the other end of which engages the cam 76. The latch piston 78 has a retainer 84 secured thereto to limit the amount of travel of the cam 76 along the latch piston in response to the force from the detent spring 82. The interior end of the latch piston 78 also has an external seal 86 that sealingly engages the interior of the cam bore 74 to prevent fluid from flowing there between. This forms a control cavity 85 between the interior end of the latch piston 78 and the interior end of the cam bore 74.

The spool 16 has an outer surface abutting the spool bore and a plurality of transverse apertures 120 extending between that outer surface and the cam bore 74. A separate latch member in the form of a sphere 122 is received within each of those apertures 120 and engages a beveled outer surface of the cam 76. FIG. 2 shows the state of the spool latch 60 when the spool 16 is centered in the neutral position in which the valve 10 is closed. In that position, the spheres 122 are within the groove 68 in the sleeve 64 and are able to roll freely therein.

The interior end of the cam bore 74 communicates with a control passage 88 that extends axially into the spool 16, as shown in FIG. 1. At the end of the control passage 88 remote from the cam bore has a transverse aperture 90 that opens through the outer side surface of the spool 16. In the neutral position of the spool as depicted in FIG. 1, the aperture 90 is located between an opening of the bridge passage 36 into the spool bore 18 and the opening of the second workport passage 44. Referring again to FIG. 2, a poppet 92 is located at the opening of the control passage 88 into the cam bore 74. A poppet spring 94 biases the poppet 92 away from the latch piston 78 and into a position that closes the opening between the control passage 88 and the cam bore 74. A bleed orifice 96 extends through the poppet 92 to allow a small flow of fluid between the cam bore 74 and the control passage 88, as will be described.

A shoulder screw 100 is threaded into the cam bore 74 at the end of the spool 16. The shoulder screw has a tip 102 that serves as a mechanical stop for the motion of the latch piston 78 within that cam bore. The exposed end of the shoulder screw 100 has a shoulder 104 which provides a groove 106 between that shoulder and the end of the spool 16. A pair of oppositely oriented spring seats 108 and 110 are received within that groove 106 and have outer flanges that are engaged by a centering spring 112. The force of the centering spring 112 is balanced when the spool is in the neutral position shown. When the spool 16 is moved left or right from the illustrated neutral position, the centering spring 112 is compressed and thereafter provides force for returning the spool to the neutral position.

### Valve Operation

To lower the stabilizer of the backhoe, the piston 28 of the hydraulic actuator 12 moves to the left, which motion is accomplished by the operator moving the valve spool 16 leftward from the neutral position shown in FIG. 1. When the spool 16 reaches a first position within the spool bore 18, a first annular recess 48 in the spool provides a path between the supply passage 30 and the feed chamber 34, thereby conveying pressurized fluid into the feed chamber. That fluid continues to flow through the load holding check valve 38 and into the bridge passage 36. A second annular recess 50 in the spool 16 provides another fluid path from the bridge passage 36 into the second workport passage 44, from which the fluid flows out the second workport 46 and into the second chamber 24 of the hydraulic actuator 12. That action forces the piston 28 toward the left.

At that time, a third annular recess 52 in the spool 16 provides a path between the first workport passage 40 and the tank return passage 32. That path allows fluid to be exhausted from the first chamber 22 of the hydraulic actuator 12, through the valve 10 and out the tank return passage 32.

With additional reference to FIG. 2, when the spool 16 is moved left from the illustrated neutral position, the spheres 122 of the latch mechanism roll unrestricted within the groove 68. The length of the groove also allows the spheres 122 to roll freely when the operator releases the actuator lever 20 and the force of the centering spring 112 returns the spool 16 to the centered, neutral position.

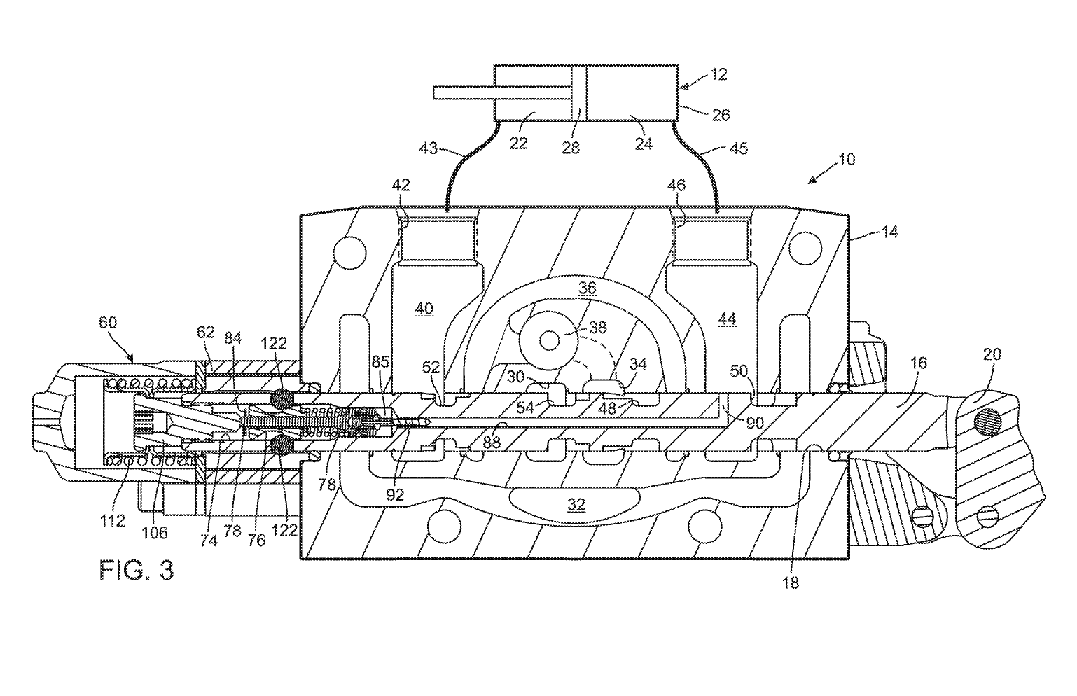

To raise the backhoe stabilizer, the piston 28 of the hydraulic actuator 12 moves to the right, which motion is accomplished by the operator moving the spool 16 rightward from the neutral position. That motion compresses the centering spring 112. When the spool reaches a second position within the spool bore 18 shown in FIG. 3, a fourth annular recess 54 near the center of the spool 16 provides a path between the supply passage 30 and the feed chamber 34, thereby furnishing pressurized fluid into the feed chamber. That fluid flows through the load holding check valve 38 and into the bridge passage 36. From the bridge passage 36, the fluid continues to flow via the third annular recess 52 into the first workport passage 40 and out the valve 10 to the first chamber 22 of the hydraulic actuator 12. That fluid forces the piston 28 toward the right in the drawings.

When the spool 16 is in the second position, the second annular recess 50 provides a path between the second workport passage 44 and the tank return passage 32. That path allows fluid to be exhausted from the second chamber 24 of the hydraulic actuator 12 and flow out of the valve 10 via the tank return passage 32.

With previous valves, the backhoe operator had to hold the actuator lever to maintain force so that the spool 16 remained in the second position until the stabilizer was fully raised. During that time, that operator only could perform limited other activities. The present valve 10 includes a latch 60 attached to the opposite end of the spool 16 from the actuator lever 20. The latch 60 holds the spool 16 in the second position until flow from the second workport passage 44 to the tank passage 32 ceases, at which time the latch releases allowing force from a centering spring 112 spring to return the spool to the neutral position, as will be described.

With reference to FIGS. 2 and 3, when the spool 16 is moved to the right, to raise the stabilizer, the initial motion causes the spheres 122 in the latch 60 to roll within the groove 68 until encountering the rib 72. The axial force applied to the spool 16 is sufficient to overcome any force applied to the spheres 122 by the cam 84 and allow the spheres to roll past the rib 72 into the detent notch 70 that acts as a catch for the latch. In that state, the spool 16 is in a second position in which the hydraulic actuator 12 is operating to raise the stabilizer.

The aperture 90 in the control passage 88 now opens into the second workport passage 44, thereby receiving the fluid being exhausted under pressure from second chamber 24 of the hydraulic actuator 12. The second annular recess 50 in the spool is sized to provide a pressure differential between the second workport passage 44 and the tank return passage 32, thereby maintaining that second workport passage at a higher pressure level than the tank return passage pressure. The pressure in the second workport passage 44 is communicated through the control passage 88 forcing open the poppet 92 and applying that pressure to the adjacent end of the latch piston 78. This action causes the latch piston 78 and the cam 76 to move together leftward within the cam bore 74. The motion of the latch piston 78 is transferred to the cam 76 by the detent spring 82. A maximum preloaded force of the detent spring 82 is established when sufficient pressure in the control passage forces the latch piston 78 into contact with the tip 102 of the shoulder screw 100. A minimum preloaded force of the detent spring 82 is determined by the location of the retainer 84 along the latch piston 78.

The motion of the latch piston 78 and the cam 76 pushes the spheres 122 (or latch members) outward within the transverse apertures 20 and completely into the annular detent notch 70 that acts as the catch of the latch. In the fully open position of the spool 16 to raise the stabilizers, the spheres 122 are captivated within the detent notch 70, because the axial force from the compressed centering spring 112 is insufficient to overcome the radial force exerted on the spheres 122 by the cam 76. Therefore, in the stabilizer raising mode, the backhoe operator can release the actuator lever 20 without the centering spring 112 moving the spool back toward the neutral position.

As long as fluid continues to flow from the hydraulic actuator 12 through the second workport passage 44 and into the tank return passage 32, the pressure differential created between those passages, when communicated to the latch piston 78 through the control passage 88, is sufficient to hold the spheres 122 within the annular detent notch 70 and inhibit motion of the spool. Therefore, even though the backhoe operator no longer is applying force to the actuator lever 20, the spool 16 remains in the second position and raising of the stabilizer continues.

When the hydraulic actuator 12 reaches the fully raised position of the stabilizer, the piston 28 strikes an end of the cylinder 26. As a result, fluid no longer is exhausted from the second chamber 24 and fluid flow through the second workport passage 44 and the second annular spool recess 50 terminates. Without flow, the pressure within the second workport passage 44 soon becomes equal to the relatively low pressure in the tank return passage 32. Thus the pressure in the control passage 88 also decreases to that lower level, at which time the poppet 92 is held against the opening of the control passage 88 in to the control cavity 85 in the cam bore 74 as shown in FIG. 2. Now, the higher pressure trapped within the control cavity 85 decays through the bleed orifice 96 in the poppet 92. Eventually the pressure control cavity 85 decreases to a level at which the latch piston 78 is able move to the right within the cam bore 74 in response to the force exerted by the detent spring 82. This motion also decreases the force that the detent spring 82 exerts on the cam 76 and thereby the outward force that the cam applies to the spheres 122. With that outward force reduced, the force of the centering spring 112 is sufficient to pull the spool 16 leftward in the drawings and move the spheres 122 past the annular rib 72. As a result, the spheres 122 move out of the detent notch 70 and into the elongated annular groove 68 in the sleeve 64. The spheres 122 are able to roll freely within that groove 68 enabling the spool 16 to continue the leftward motion until reaching the neutral position at which the centering spring 112 no longer applies a movement force to the spool.

Once the actuator 12 has reached the fully raised position of the stabilizer, the lack of flow from the actuator through the valve 10 and into the tank return passage 32 releases the latch 60 enabling force from the centering spring 112 to return the spool 16 to the neutral, centered position at which the valve is closed.

With reference to FIG. 1, when the spool 16 is moved to the right to raise the stabilizer, the aperture 90, at the interior end of the control passage 88 in the spool, opens into the bridge passage 36. Thus the relatively high pressure from the pump is conveyed to the latch 60 at the opposite end of that control passage. That pressure forces the poppet 92 open applying the supply pressure to the adjacent end of the latch piston 78, which tends to push the latch piston left, and the cam 76 coupled thereto, leftward in the cam bore 74. The leftward motion of the cam 76 with respect to the spool 16 applies force to the spheres 122 that pushes the spheres outward through the transverse apertures 120. However, that outward force does not adversely affect the ability of the spheres 122 to roll within the elongated annular groove 68 as the spool 16 moves within the sleeve 64. As a consequence, the effect of the supply pressure being transmitted to the end of the latch piston 78 does not cause the latch 60 to restrict or inhibit the spool motion.

The foregoing description was primarily directed to one or more embodiments of the invention. Although some attention has been given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

I claim:

1. A hydraulic valve comprising:
a body having a spool bore therein and a supply passage for receiving pressurized fluid, a tank return passage for connection to a tank, and a workport for connection to a hydraulic actuator;
a spool slideably received in the spool bore and having a first position in which a first fluid path is provided between the supply passage and the workport, a second position in which a second fluid path is provided between the tank return passage and the workport, and a neutral position in which the workport is closed off from both the supply passage and the tank return passage, wherein the spool has a control passage that in the second position is in fluid communication with the workport; and
a latch responsive to pressure in the control passage to inhibit motion of the spool when the spool is in the second position;
wherein while the spool is in the second position, fluid flowing from the workport to the tank return passage applies a first pressure level from the workport to the control passage which exerts a force on the latch thereby inhibiting motion of the spool with respect to the body, and when the fluid flow from the workport to the tank return passage terminates, a second pressure level is applied from the workport to the control passage which causes the latch to allow the spool to move with respect to the body.

2. The hydraulic valve as recited in claim 1 wherein the latch comprises a cam that moves in response to pressure in the control passage, a latch member engaged by a surface of the cam, and a catch; wherein the first pressure level causes the cam to hold the latch member in engagement with the catch, thereby inhibiting the spool from moving from the second position; and the second pressure level causes the cam to allow the latch member to disengage from the catch, thereby enabling the spool to move from the second position.

3. The hydraulic valve as recited in claim 2 further comprising a latch piston coupled to the cam, wherein pressure in the control passage is applied to the latch piston.

4. The hydraulic valve as recited in claim 3 further comprising a detent spring biasing the cam with respect to the latch piston.

5. The hydraulic valve as recited in claim 2 wherein the spool has a cam bore;
the cam is moveably received within the cam bore; the spool has an aperture extending between the cam bore and the spool bore with the latch member being received within the aperture; and the catch is a notch within the spool bore.

6. A hydraulic valve comprising:
a valve housing having a spool bore therein and a supply passage for receiving pressurized fluid, a tank return passage for connection to a tank, and a workport for connection to a hydraulic actuator;
a spool slideably received in the spool bore and having a first position in which a first fluid path is provided between the supply passage and the workport, a second position in which a second fluid path is provided between the tank return passage and the workport, and a neutral position in which the workport is closed off from both the supply passage and the tank return passage, wherein the spool has a control passage; and
a latch assembly comprising a latch housing with a detent bore and a catch formed in the detent bore, a latch casing moveably received within the detent bore and attached to move with the spool, a cam bore is formed in the latch casing, a latch piston slideably received in the cam bore and defining a control cavity that is in fluid communication with the control passage, a cam within the cam bore and operatively coupled to the latch piston, and a latch member engaged by a surface of the cam;
wherein while the spool is in the second position, fluid flow from the workport to the tank return passage being above a given amount produces a first pressure level that is communicated through the control passage to the control cavity, thereby causing the cam to hold the latch member in engagement with the catch which inhibits the spool from moving from the second position; and when the fluid flow from the workport to the tank return passage is below the given amount, a second pressure level is communicated through the control passage to the control cavity, thereby permitting the cam to allow the latch member to disengage the catch which enables the spool to move from the second position.

7. The hydraulic valve as recited in claim 6 wherein the latch assembly is attached to one end of the spool.

8. The hydraulic valve as recited in claim 6 wherein the latch casing is a portion of the spool.

9. The hydraulic valve as recited in claim 6 wherein the detent bore opens into the spool bore.

10. The hydraulic valve as recited in claim 6 wherein the latch casing further comprises an aperture extending between the cam bore and the detent bore, with the latch member being moveably received within the aperture.

11. The hydraulic valve as recited in claim 6 wherein the latch member is a sphere that abuts the cam; and the catch is a notch in a wall of the detent bore.

12. The hydraulic valve as recited in claim 6 further comprising a detent spring biasing the cam away from an end of the latch piston at which the control cavity is defined.

13. The hydraulic valve as recited in claim 6 further comprising a poppet coupled to the latch piston for selectively restricting fluid flow from the control passage into the control cavity.

14. The hydraulic valve as recited in claim 13 wherein the poppet has an orifice through which fluid is able to flow between the control passage and the control cavity.

15. The hydraulic valve as recited in claim 6 wherein the cam bore has a groove extending longitudinally therein and separated from the groove, wherein the latch member is received in the groove in the first position of the spool.

16. A hydraulic valve comprising:
a body having a supply passage for receiving pressurized fluid, a tank return passage for connection to a tank, a workport for connection to a hydraulic actuator, and a spool bore into which the supply passage, the tank return and the workport open, the spool bore having a groove extending longitudinally therein and having a notch separated from the groove;
a spool with a cam bore at one end, an aperture extending between the cam bore and a spool bore, and a control passage extending axially from the cam bore and having an opening in an exterior surface of the spool, the spool slideably received in the spool bore and having a first position in which a first fluid path is provided between the supply passage and the workport, a second position in which a second fluid path is provided between the tank return passage and the workport and in which the opening is in fluid communication with the workport, and a neutral position in which the workport is closed off from both the supply passage and the tank return passage; and
a latch comprising a latch piston moveably received in the cam bore and defining a control cavity that is in fluid communication with the control passage, a cam moveably received within the cam bore and operatively connected to move with the latch piston, and a sphere within the aperture in the spool and engaged by the cam, wherein in the first position of the spool the sphere is received in the groove and in the second position of the spool the sphere is received in the notch;
wherein while the sphere is received in the notch, fluid flow from the workport to the tank return passage produces a first pressure level that is communicated through the control passage to the control cavity, thereby causing the cam to apply a force to the sphere that restricts the sphere from moving from the notch, which inhibits the spool from moving from the second position; and when the fluid flow from the workport to the tank return passage terminates, a second pressure level is communicated through the control passage to the control cavity, thereby causing the cam to alter the force applied to the sphere that allows the sphere to move from the notch into the groove and enables the spool to move from the second position.

17. The hydraulic valve as recited in claim 16 further comprising a detent spring biasing the cam with respect to the latch piston.

18. The hydraulic valve as recited in claim 16 wherein the cam slides on the latch piston, and further comprising a detent spring biasing the cam away from an end of the latch piston.

19. The hydraulic valve as recited in claim 18 wherein the latch piston has a retainer that limits movement of the cam away from the end of the latch piston.

20. The hydraulic valve as recited in claim 16 further comprising a poppet coupled to the latch piston for selectively restricting fluid flow from the control passage into the control cavity.

21. The hydraulic valve as recited in claim 20 wherein the poppet is coupled to the latch piston by a poppet spring.

22. The hydraulic valve as recited in claim 20 wherein the poppet has an orifice through which fluid is able to flow between the control passage and the control chamber.
